(19) United States
(12) Patent Application Publication
(10) Pub. No.: US 2015/0349380 A1
(43) Pub. Date: Dec. 3, 2015

(54) ELECTROLYTE ADDITIVES FOR LITHIUM-SULFUR BATTERIES

(71) Applicant: BOARD OF REGENTS, THE UNIVERSITY OF TEXAS SYSTEM, Austin, TX (US)

(72) Inventors: Arumugam Manthiram, Austin, TX (US); Chenxi Zu, Austin, TX (US)

(21) Appl. No.: 14/710,859

(22) Filed: May 13, 2015

Related U.S. Application Data
(60) Provisional application No. 62/004,603, filed on May 29, 2014.

(51) Int. Cl. H01M 10/0567; H01M 10/052; H01M 10/0568; H01M 4/13; H01M 4/136; H01M 10/0569; H01M 4/134

(52) U.S. Cl. CPC H01M 10/0567; H01M 10/0569; H01M 10/052; H01M 4/134; H01M 4/13; H01M 4/136; H01M 10/0568; H01M 2004/027

(57) ABSTRACT

The present disclosure relates to a lithium-sulfur rechargeable battery containing a lithium metal anode, a sulfur-containing cathode, and an electrolyte containing an additive of the formula M-X, where M is a transition metal and X is an anion, and where the additive helps form a passivation layer on the lithium metal anode.

### PRIORITY

This application claims priority to U.S. Provisional Patent Application No. 62/004,603 filed May 29, 2014, the contents of which is hereby incorporated by reference in its entirety.

### STATEMENT OF GOVERNMENT INTEREST

This invention was made with government support under Grant no. DE-SC0005397 awarded by the Department of Energy. The government has certain rights in the invention.

### TECHNICAL FIELD

The current disclosure relates to electrolyte additives for electrochemical cells.

### BACKGROUND

### Basic Principles of Batteries and Electrochemical Cells

Batteries may be divided into two principal types, primary batteries and secondary batteries. Primary batteries may be used once and are then exhausted. Secondary batteries are also often called rechargeable batteries because after use they may be connected to an electricity supply, such as a wall socket, and recharged and used again. In secondary batteries, each charge/discharge process is called a cycle. Secondary batteries eventually reach an end of their usable life, but typically only after many charge/discharge cycles.

Secondary batteries are made up of an electrochemical cell and optionally other materials, such as a casing to protect the cell and wires or other connectors to allow the battery to interface with the outside world. An electrochemical cell includes two electrodes, the positive electrode or cathode and the negative electrode or anode, an insulator separating the electrodes so the battery does not short out, and an electrolyte that chemically connects the electrodes.

In operation the secondary battery exchanges chemical energy and electrical energy. During discharge of the battery, electrons, which have a negative charge, leave the anode and travel through outside electrical conductors, such as wires in a cell phone or computer, to the cathode. In the process of traveling through these outside electrical conductors, the electrons generate an electrical current, which provides electrical energy.

At the same time, in order to keep the electrical charge of the anode and cathode neutral, an ion having a positive charge leaves the anode and enters the electrolyte and then a positive ion leaves the electrolyte and enters the cathode. In order for this ion movement to work, typically the same type of ion leaves the anode and joins the cathode. Additionally, the electrolyte typically also contains this same type of ion. In order to recharge the battery, the same process happens in reverse. By supplying energy to the cell, electrons are induced to leave the cathode and join the anode. At the same time a positive ion, such as Li⁺, leaves the cathode and enters the electrolyte and a Li⁺ leaves the electrolyte and joins the anode to keep the overall electrode charge neutral.

In addition to containing an active material that exchanges electrons and ions, anodes and cathodes often contain other materials, such as a metal backing to which a slurry is applied and dried. The slurry often contains the active material as well as a binder to help it adhere to the backing and conductive materials, such as a carbon particles. Once the slurry dries, it forms a coating on the metal backing.

Unless additional materials are specified, batteries as described herein include systems that are merely electrochemical cells as well as more complex systems.

Several important criteria for rechargeable batteries include energy density, power density, rate capability, cycle life, cost, and safety. The current lithium-ion battery technology based on insertion compound cathodes and anodes is limited in energy density. This technology also suffers from safety concerns arising from the chemical instability of oxide cathodes under conditions of overcharge and frequently requires the use of expensive transition metals. Accordingly, there is immense interest to develop alternate cathode materials for lithium-ion batteries. Sulfur has been considered as one such alternative cathode material.

### Lithium-Sulfur Batteries

Lithium-sulfur (Li—S) batteries are a particular type of rechargeable battery. Unlike current lithium-ion batteries in which the ion actually moves into and out of a crystal lattice, the ion in lithium-sulfur batteries reacts with sulfur in the cathode to produce a discharge product with different crystal structure. In most Li—S batteries, the anode is lithium metal (Li or Li⁰). In operation, lithium leaves the metal as lithium ions (Li⁺) and enters the electrolyte when the battery is discharging. When the battery is recharged, lithium ions (Li⁺) leave the cathode and plate out on the lithium metal anode as lithium metal (Li). At the cathode, during discharge, particles of elemental sulfur (S) react with the lithium ion (Li⁺) to form Li₂S. When the battery is recharged, lithium ions (Li⁺) leave the cathode, allowing to revert to elemental sulfur (S).

Sulfur is an attractive cathode candidate as compared to traditional lithium-ion battery cathodes because it offers an order of magnitude higher theoretical capacity (1672 mAh g⁻¹) than the currently employed cathodes (<200 mAh g⁻¹) and operates at a safer voltage range (1.5-2.5 V). This high theoretical capacity is due to the ability of sulfur to accept two electrons (e) per atom. In addition, sulfur is inexpensive and environmentally benign.

However, the practical applicability of Li—S batteries is presently limited by their poor cycle stability. The discharge of sulfur cathodes involves the formation of intermediate polysulfide ions, which dissolve easily in the electrolyte during the charge-discharge process and result in an irreversible loss of active material during cycling. The high-order polysulfides (Li₂Sₙ, 4≦n≦8) produced during the initial stage of the discharge process are soluble in the electrolyte and move toward the lithium metal anode, where they are reduced to lower-order polysulfides. Moreover, solubility of these high-order polysulfides in the liquid electrolytes and nucleation of the insoluble low-order sulfides (i.e., Li₂S₂ and Li₂S) result in poor capacity retention and low Coulombic efficiency. In addition, shuttling of these high-order polysulfides between the cathode and anode during charging, which involves parasitic reactions with the lithium anode and re-oxidation at the cathode, is another challenge. This process results in irreversible capacity loss and causes the build-up of a thick, irreversible Li₂S barrier on the electrodes during prolonged cycling, which is electrochemically inaccessible.

Recent improvements in cathode design, such as the implementation of conductive porous materials to encapsulate sulfur within the cathode and suppress polysulfide shuttling, have produced Li—S batteries having high performance. Such improvements, however, are associated with limited sulfur content (and thus cathode capacity and energy density) and cycle time. With increased sulfur content or extended cycle time, polysulfide dissolution and shuttling are inevitable and directly impair the stability of the lithium metal anode, as parasitic reactions between dissolved polysulfides and the lithium metal anode lead to lithium dendrite formation and electrolyte depletion. It is impossible to produce a viable rechargeable Li—S battery without solving the problem of lithium-metal anode deterioration.

The stability of the lithium metal anode depends primarily on the stability of the passivation layer or surface electrode interface (SEI) that is formed on the lithium surface. The composition and microstructure of the passivation film is greatly influenced by the electrolyte. Lithium nitrate (Li(NO₃)) electrolyte additives for Li—S batteries have been shown to decrease polysulfide shuttling, leading to higher reversible capacities. LiNO₃ decomposes on the lithium-metal surface, but is not able to form a stable or robust passivation layer and is consumed continuously during cycling. LiNO₃ is therefore limited in its ability to stabilize the lithium anode for long-term cycling in polysulfide-rich environments.

Accordingly, a need exists for Li—S battery electrolyte additives that stabilize the lithium anode over extended cycling and in the presence of high concentrations of polysulfides.

### SUMMARY

In one aspect, the present disclosure relates to a Li—S rechargeable battery including an electrolyte comprising an additive of the formula M-X, where M is a transition metal and X is an anion.

In one aspect, the present disclosure provides electrolyte additives for electrochemical cells that react with an anode in situ to form a robust passivation layer on the surface of the anode. The passivation layer can function to protect the anode from parasitic reactions and/or control deposition of chemical species on the anode to prevent physical degradation of the anode during cycling. In certain embodiments, the anode includes a lithium metal anode surface. The disclosed electrolyte additives can form a robust passivation layer on the lithium metal anode surface. The passivation layer can inhibit lithium dendrite formation by controlling sites of lithium deposition on the lithium metal anode surface. The passivation layer can additionally or alternatively protect the lithium metal anode from parasitic reactions.

The following abbreviations are commonly used throughout the specification:
Li⁺—lithium ion
Li or Li⁰—elemental or metallic lithium or lithium metal
S—sulfur
Li—S—lithium-sulfur
Li₂S—lithium sulfide
LiCF₃SO₃—lithium trifluoromethanesulfonate
CNF—carbon nanofiber
OCV—open circuit voltage
DME—dimethoxyethane
DOL—1,3-dioxolane
SEM—scanning electron microscope
XRD—X-ray diffraction
XPS—X-ray photon spectroscopy

### BRIEF DESCRIPTION OF THE DRAWINGS

A more complete understanding of the present embodiments and advantages thereof may be acquired by referring to the following description taken in conjunction with the accompanying drawings, which relate to embodiments of the present disclosure. The current specification contains color drawings. Copies of these drawings may be obtained from the USPTO.

FIG. 1A provides a schematic illustration of a Li—S battery having a CNF paper electrode and a dissolved polysulfide catholyte in accordance with certain embodiments of the present disclosure.

FIG. 1B provides a plot of discharge/charge voltage profiles for the first and second discharge/charge cycles of a Li—S battery constructed as schematically illustrated in FIG. 1A, without M-X additive (“control cell”), and cycled at a rate of C/5 (1 C=1,672 mA g⁻¹).

FIG. 1C provides a plot of discharge/charge voltage profiles for the first, 25^{th}, and 100^{th} discharge/charge cycles of a Li—S battery constructed as schematically illustrated in FIG. 1A with M-X additive (copper acetate) (“additive cell”), and cycled at a rate of C/5.

FIG. 1D provides a plot of cycling performance (discharge capacity and Coulombic efficiency) of the control cell (“control cell”) and additive cell (“experimental cell”) over up to 300 cycles at a rate of C/5.

FIG. 2A provides the Nyquist plots of electrical impedance before cycling, after the first charge, and after the 100^{th} charge, of the control cell at a cycling rate of C/5, and provides an inset schematic of the equivalent circuit.

FIG. 2B provides the Nyquist plots before cycling, after the first charge, and after the 100^{th} charge, of the additive cell at a cycling rate of C/5, and provides an inset schematic of the equivalent circuit.

FIG. 3 provides a plot of discharge capacity over cycles 1-13 of a Li—S battery having a sandwich-structured cathode and containing copper acetate. The cathode structure is illustrated schematically in the inset, wherein CNF 2 represents the pristine CNF paper current collector and CNF 1 represents the modified CNF paper current collector with carbon and polymer coating.

FIG. 4 provides plots of discharge capacity for cycles 1-10 of control Li—S batteries (having sandwich-structured cathodes) and cells containing copper acetate (having sandwich-structured cathodes) at cycle rates of C/2 and 1 C.

FIG. 5 provides plots of discharge capacity for cycles 1-10 of Li—S batteries having sandwich-structured cathodes and containing 0.03 M copper acetate, 0.015 M copper acetate, or 0.0015 M copper acetate, at a cycle rate of C/5.

FIG. 6 provides plots of discharge capacity over up to 20 cycles for Li—S batteries with and without M-X additive (copper acetate) and constructed with a sulfur cathode deposited on an aluminum foil current collector, at a cycle rate of C/2.

FIGS. 7A-7D provide SEM micrographs of the lithium metal anode surfaces of the control cell and the additive cell after cycling at a rate of C/5, the scale bars representing a length of 100 um, wherein:

FIG. 7A shows the control cell anode surface after the first charge;

FIG. 7B shows the additive cell anode surface after the first charge;

FIG. 7C shows the control cell anode surface after the 100^{th} charge; and

FIG. 7D shows the additive cell anode surface after the 100^{th} charge.

FIGS. 8A-8D provide EDS elemental mapping overlays on the micrographs of FIGS. 7A-7D, with sulfur shown in red and copper shown in blue, wherein:

FIG. 8A shows the control cell anode surface after the first charge;

FIG. 8B shows the additive cell anode surface after the first charge;

FIG. 8C shows the control cell anode surface after the 100^{th} charge; and

FIG. 8D shows the additive cell anode surface after the 100^{th} charge.

FIGS. 9A-9B provide SEM micrographs showing lithium extraction from the lithium metal anode surfaces of the control cell and the additive cell after the first discharge at a rate of C/5, the scale bars representing a length of 100 um, wherein

FIG. 9A shows the control cell anode; and

FIG. 9B shows the additive cell anode.

FIG. 10A provides a cross sectional EDS line scan showing intensity of sulfur signal along a cross-section of the lithium metal anode of the control cell after the 100^{th} cycle with cycling at a rate of C/5. The direction of the scan is provided in the inset.

FIG. 10B provides a cross sectional EDS line scan showing intensity of sulfur signal along cross-section of the lithium metal anode of the additive cell after the 100^{th} cycle with cycling at a rate of C/5. The direction of the scan is provided in the inset.

FIGS. 11A and 11B provide SEM micrographs of the lithium metal anode of the control cell and the additive cell corresponding to the cross-sectional line scans of FIG. 10A and FIG. 10B, wherein

FIG. 11A shows the cross-section of the control cell anode; and

FIG. 11B shows the cross-section of the additive cell anode.

FIG. 12A provides a TOF-SIMS chemical mapping image of a 100 μm² field at the surface of the passivation layer of the lithium metal anode of the additive cell after the first charge, with sulfur signal shown in red and copper signal shown in blue.

FIG. 12B provides a TOF-SIMS chemical mapping image of a 100 μm² field at the surface of the passivation layer of the lithium metal anode of the additive cell after the first charge, with sulfur signal shown in red and lithium signal shown in blue.

FIG. 12C provides XRD patterns of the lithium metal anode of the additive cell after the first discharge.

FIG. 12D provides XRD patterns of the lithium metal anode of the additive cell after the first charge.

FIG. 12E provides a schematic model of lithium deposition on the lithium metal anode in Li—S batteries containing M-X additive (e.g., copper acetate).

FIG. 13A provides high resolution S 2p XPS spectra of the surface of the lithium anode of the control (“control”) and additive (“experimental”) cells after the first charge. The cells were cycled at a rate of C/5.

FIG. 13B provides high resolution S 2p XPS spectra of the surface of the lithium anode of the control (“control”) and additive (“experimental”) cells after the 100^{th} charge. The cells were cycled at a rate of C/5.

FIG. 13C provides the UV-visible absorption spectra of the cathode analyte after the 100^{th} charge. The cells were cycled at a rate of C/5.

FIG. 14 provides a plot of discharge capacity over cycles 1-45 of a Li—S battery without M-X additive at a cycle rate of C/2.

FIG. 15 provides a plot of discharge capacity and Coulombic efficiency over cycles 1-200 of a Li—S battery with M-X additive (copper nitrate) at a high cycle rate of 1 C.

FIG. 16 provides Nyquist plots of electrical impedance of Li—S batteries containing M-X additive (copper nitrate) at a concentration of 0.05 M, 0.1 M, or 0.5 M and a cathode sulfur content of 60% by weight or 70% by weight, as indicated.

FIG. 17 provides a plot of discharge capacity over cycles 1-10 of a Li—S battery containing M-X additive (copper fluoride) at a cycle rate of C/2.

FIG. 18 provides a plot of discharge capacity over cycles 1-50 of Li—S batteries containing an M-X additive (copper acetate, nickel (II) acetate, or iron (II) acetate, as indicated) at a cycle rate of C/2.

### DETAILED DESCRIPTION

One aspect of the current disclosure provides an electrochemical cell comprising an anode, a cathode, an electrolyte, and one or more electrolyte additives of the formula M-X, where M is a transition metal and X is an anion. In accordance with the present disclosure, the anode can be composed of any suitable anode material susceptible to degradation in an electrochemical cell. In certain embodiments, the anode is a metal anode. By way of example and not limitation, the metal anode can be composed of a metal selected from the group consisting of lithium, sodium, potassium, magnesium, calcium, zinc, aluminum, yttrium, and combinations thereof. In certain embodiments, the electrochemical cell is a rechargeable Li—S battery.

### Li—S Batteries

In certain non-limiting embodiments, the current disclosure provides an electrochemical cell comprising an anode, the anode comprising lithium; a cathode and/or catholyte comprising a material comprising electroactive sulfur; and an electrolyte, the electrolyte comprising one or more additives of the formula M-X, where M is a transition metal and X is an anion. The electrochemical cell can further comprise a separator between the anode and the cathode.

### a) Anode Comprising Lithium

In certain embodiments, the battery contains an anode comprising lithium. The anode can be made of any material in which lithium ions (Li⁺) can intercalate or be deposited. Suitable anode materials include, without limitation, lithium metal (Li or Li⁰ anode), such as lithium foil and lithium deposited on a substrate, lithium alloys, including silicon-lithium alloys, tin-lithium alloys, aluminum-lithium alloys, and magnesium-lithium alloys, and lithium intercalation materials, including lithiated carbon, lithiated tin, and lithiated silicon.

The anode can have any structure suitable for use in a given electrochemical cell. The anode may be arranged in a single-layer configuration or a multi-layer configuration. Suitable anode configurations include, for example, the multi-layer configurations disclosed in U.S. Pat. No. 8,105,717 to Skotheim et al., hereby incorporated herein by reference in its entirety.

### b) Cathodes, Catholytes, and Separators

In certain embodiments, the cathode comprises a material containing electroactive sulfur. By way of example and not limitation, the cathode can comprise elemental sulfur, including, without limitation, crystalline sulfur, amorphous sulfur, precipitated sulfur, and melt-solidified sulfur, sulfides, polysulfides, sulfur oxides, organic materials comprising sulfur, and combinations thereof. Where the cathode comprises elemental sulfur, the elemental sulfur can be coated with a conductive material, such as a conductive carbon.

The cathode can have any configuration suitable for use in a given electrochemical cell. For example, the cathode can be of single-layer construction, such as elemental sulfur deposited on a current collector, or multi-layer configuration.

Additionally or alternatively, certain embodiments in accordance with the present disclosure can contain a conductive cathode and a polysulfide catholyte. A “catholyte” as used herein, refers to a battery component that both functions as an electrolyte and contributes to the cathode. In such embodiments, the cathode can comprise a conductive electrode, such as a carbon nanofiber electrode. By way of example and not limitation, suitable catholytes and cathodes are disclosed in U.S. Patent No. 2013/0141050 to Visco et al. and U.S. patent application Ser. No. 13/793,418 to Manthiram et al., filed Mar. 11, 2013, both of which are hereby incorporated by reference in their entireties.

The polysulfide catholyte can contain a polysulfide with a nominal molecular formula of Li₂S₆. The polysulfide can, in some embodiments, contain components with the formula Li₂Sₙ, where 4≦n≦8. In a more specific embodiment, the polysulfide can be present in an amount with a sulfur concentration of 1-8 M, more specifically, 1-5 M, even more specifically 1-2 M. For example, it can be present in a 1M amount, a 1.5 M amount, or a 2 M amount. The catholyte can also contain a material in which the polysulfide is dissolved. For example, and as discussed below, the catholyte can also contain LiCF₃SO₃, LiTFSI, LiNO₃, dimethoxy ethane (DME), 1,3-dioxolane (DOL), tetraglyme, other lithium salt, other ether-based solvents, and any combinations thereof.

The battery can further contain an electrically insulative separator between the cathode and anode. In embodiments containing a catholyte, the separator can be permeable to the catholyte. Alternatively, in solid electrolyte systems, the separator can also be the electrolyte conducing lithium ions. Other separators may also be used, so long as the cathode and anode remain sufficiently electrically disconnected to allow battery function. The separator may commonly be a polymer, gel, or ceramic.

### c) Electrolytes

The electrolyte can be any electrolyte suitable for use in an electrochemical cell and suitable for use with the electrolyte additives disclosed herein. In preferred embodiments, the electrolyte is a nonaqueous electrolyte and is in direct contact with the anode comprising lithium. The nonaqueous electrolyte can be a liquid electrolyte, such as a nonionic liquid or an organic liquid.

In certain embodiments, the liquid electrolyte includes one or more organic solvents. Suitable organic solvents include, without limitation, acyclic ethers such as diethyl ether, dipropyl ether, dibutyl ether, dimethoxymethane, trimethoxymethane, dimethoxyethane, diethoxyethane, 1,2-dimethoxypropane, and 1,3-dimethoxypropane, cyclic ethers such as tetrahydrofuran, tetrahydropyran, 2-methyltetrahydrofuran, 1,4-dioxane, 1,3-dioxolane, and trioxane, polyethers such as diethylene glycol dimethyl ether (diglyme), triethylene glycol dimethyl ether (triglyme), tetraethylene glycol dimethyl ether (tetraglyme), higher glymes, ethylene glycol divinylether, diethylene glycol divinylether, triethylene glycol divinylether, dipropylene glycol dimethyl ether, and butylene glycol ethers, and sulfones such as sulfolane, 3-methyl sulfolane, and 3-sulfolene. In certain embodiments, the liquid electrolyte comprises a mixture of organic solvents. Suitable organic solvent mixtures include, without limitation, those disclosed in U.S. Pat. No. 6,225,002 to Nimon et al., hereby incorporated herein by reference in its entirety.

In certain embodiments, the electrolyte includes one or more ionic electrolyte salts. Preferably, the one or more ionic electrolyte salts includes one or more ionic lithium electrolyte salt. Suitable ionic lithium electrolyte salts include, without limitation, LiSCN, LiBr, LiI, LiClO4, LiAsF₆, LiCF₃SO₃, LiSO₃CH₃, LiBF₄, LiB(Ph)₄, LiPF₆, LiC(SO₂CF₃)₃, and LiN(SO₂CF₃)₂.

### d) Electrolyte Additive

Lithium anodes in Li—S batteries develop a surface film or solid electrolyte interface (SEI), also referred to herein as a passivation layer, due to chemical reactions with components of the cell, including electrolyte salts and sulfides and polysulfides evolved from the cathode. The SEI can advantageously release lithium ions during cycling while limiting lithium consumption by cathode species. Polysulfide deposition on the lithium anode, however, is electrochemically irreversible and corrodes and insulates the anode, resulting in reduced discharge voltage and cell capacity.

In accordance with the present disclosure, one or more electrolyte additives of the formula M-X is provided, where M is any transition metal and X is any anion. The one or more electrolyte additives can be any transition metal salt. By way of example and not limitation, the transition metal of the additive can be scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, gold, mercury, rutherfordium, dubnium, seaborgium, bohrium, hassium, meitnerium, ununbium, and combinations thereof. The transition metal can have any of its oxidation states. Further by way of example, suitable anions include, without limitation, F⁻, Cl⁻, Br⁻, I⁻, NO₃⁻, PO₄³⁻, SO₄²⁻, SO₃²⁻, C₂O₄²⁻, CH₃(COO)⁻, and combinations thereof.

The transition metal salt additives dissociate in the electrolyte in the cell. Prior to and during initial cycling of the cell, the transition metal ions of the additive are stably incorporated into the SEI to form a stable passivation layer on the surface of the anode. Without limitation by theory, experimental observations indicate that incorporation of the transition metal ions into the SEI to form a stable passivation layer results in controlled deposition of lithium ions at the anode, thereby preventing the formation of lithium dendrites. The stable passivation layer further prevents the deposition and infiltration of corrosive polysulfide species and associated parasitic reactions between the anode and polysulfide species. Accordingly, in certain embodiments, the electrolyte additives of the present disclosure result in at least one of improved cycle stability and higher Coulombic efficiency relative to prior art Li—S batteries.

The transition metal salt additives can be selected based on performance in a test cell or based on their predicted performance in a given cell. Performance of cells containing the transition metal salt additives can correlate to the chemical properties of the transition metal ions, including expected resistivity and the predicted stability of the interface between the lithium anode and the transition metal. The chemical reactivity of the transition metals with sulfur species can further influence the performance of cells containing the transition metal salt additives, as the interaction between the transition metal cation and sulfur species in the electrolyte may also influence the formation and robustness of the passivation layer. The relative cost of the transition metal and its environmental impact are also significant considerations. Copper is one exemplary presently preferred transition metal for use with the additives disclosed herein.

The anion of the transition metal salt can control the release of the transition metal cation in solution based on the dissociation rate of the selected salt to influence the formation and robustness of the passivation layer. The selection of the anion can be based on, among other things, the dissociation rate of the salt, the composition of the electrolyte, and the desired electrochemical composition of the cell. Relatively highly corrosive anions (i.e., strong Lewis acids) may impair formation of the passivation layer and may diminish the stability of the passivation layer. Where stable cyclability is paramount, less polar anions, such as acetate, may be preferred.

The electrolyte additives of the present disclosure can be provided at any suitable concentration. For example, the additives can be provided at a concentration between about 0.001 M and about 1 M, or between about 0.01 M and 0.5 M, or about 0.1 M and about 0.2 M. The determination of suitable concentration will depend on, among other factors, the surface area of the lithium metal anode to be passivated. The one or more M-X additives can be incorporated directly into the electrolyte of the electrochemical cell or can be added to the cell by incorporation into or upon any of the components of the cell.

In one specific embodiment, the metal salt results in the formation of passivation layer having a three dimensional matrix structure. In one example, the matrix may include Li₂S, Li₂S₂, and MS products, such as CuS and Cu₂S and, optionally, electrolyte decomposition products.

In certain embodiments of the present disclosure, the electrolyte can contain, in addition to one or more additives of the formula M-X, further additives to improve cycle stability of the cell. Suitable additives include, by way of example and not limitation, lithium nitrate and related additives as disclosed in U.S. Pat. No. 7,553,590 to Michaylek.

### Electrochemical Performance

Batteries according to the present disclosure can have a discharge capacity of at least 1100 mAh/g (based on mass of sulfur atoms) at a rate of C/2. They can have a discharge capacity of at least 1300 mAh/g (based on mass of sulfur) at a rate of C/5. They can have a discharge capacity of at least 1400 mAh/g (based on mass of sulfur) at a rate of C/10.

Batteries according to the present disclosure may have a capacity of at least 1.0 e⁻ per sulfur atom at C/2 through C/10. More specifically, capacity may be at least 2.0 e⁻ per sulfur atom at C/10, or at least 1.5 e⁻ per sulfur atom at C/2.

Batteries according to the present disclosure may retain at least 85% of their discharge capacity over 50 cycles or even over 100 cycles when cycled between 1.8 V and 3.0 V. In more specific embodiments, they may retain at least 88% or even at least 93% of their discharge capacity over 50 cycles or even over 100 cycles when cycled between 1.8 V and 3.0 V. Batteries may retain at least 85%, at least 88%, or at least 93% of their discharge capacity over even 200 cycles if cycled in a narrow voltage window, such as 1.8 V to 2.2 V.

Batteries according to the present disclosure may have a Coulombic efficiency of at least 95%.

Batteries of the present disclosure may contain contacts, a casing, or wiring. In the case of more sophisticated batteries, they may contain more complex components, such as safety devices to prevent hazards if the battery overheats, ruptures, or short circuits. Particularly complex batteries may also contain electronics, storage media, processors, software encoded on computer readable media, and other complex regulatory components.

Batteries may be in traditional forms, such as coin cells or jelly rolls, or in more complex forms such as prismatic cells. Batteries may contain more than one electrochemical cell and may contain components to connect or regulate these multiple electrochemical cells.

Batteries of the present disclosure may be used in a variety of applications. They may be in the form of standard battery size formats usable by a consumer interchangeably in a variety of devices. They may be in power packs, for instance for tools and appliances. They may be usable in consumer electronics including cameras, cell phones, gaming devices, or laptop computers. They may also be usable in much larger devices, such as electric automobiles, motorcycles, buses, delivery trucks, trains, or boats. Furthermore, batteries according to the present disclosure may have industrial uses, such as energy storage in connection with energy production, for instance in a smart grid, or in energy storage for factories or health care facilities, for example in the place of generators.

The details of these processes and battery components that may be formed are described above or in the following examples.

### EXAMPLES

The following examples are provided to further illustrate specific embodiments of the disclosure. They are not intended to disclose or describe each and every aspect of the disclosure in complete detail and should not be so interpreted.

### Example 1

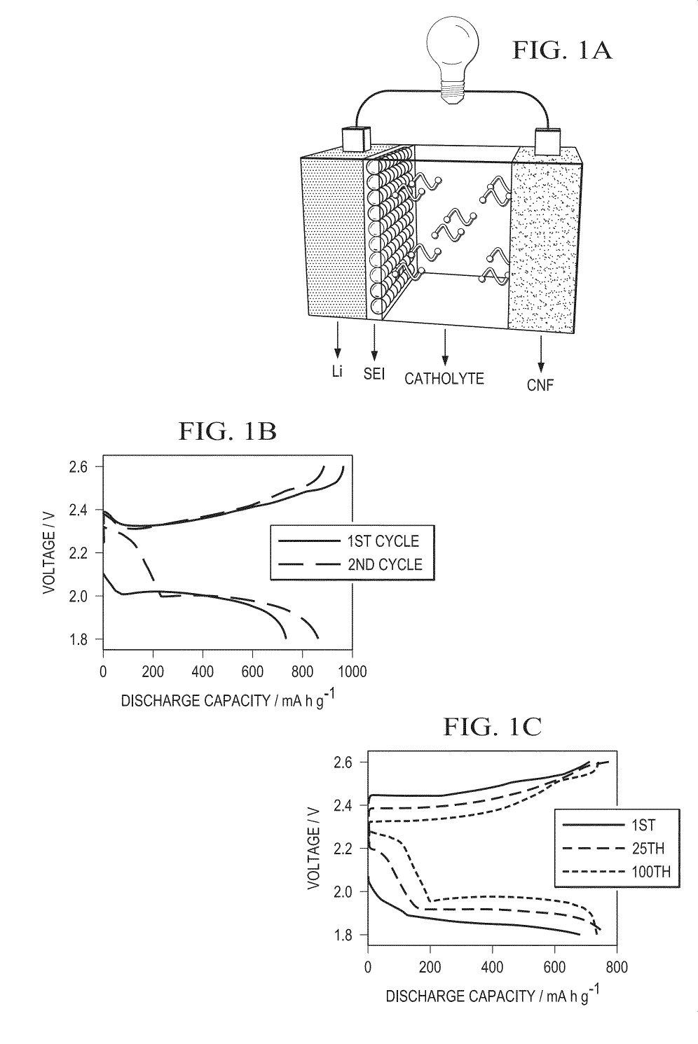

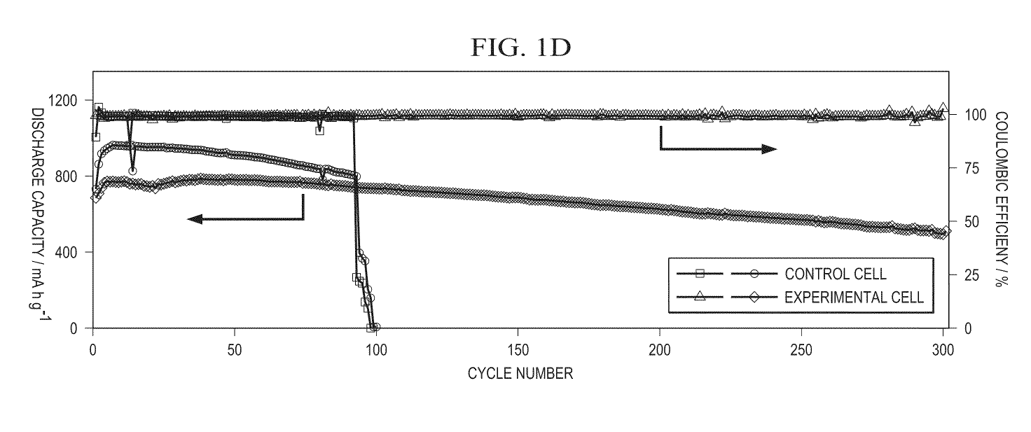

Lithium/dissolved polysulfide rechargeable Li—S batteries (CR2032 coin cells) as shown schematically in FIG. 1A were assembled in an Ar-filled glove box. The CNF paper electrode was inserted into the cell. Subsequently, 40 μL of polysulfide catholyte was added into the CNF paper electrode. Then a Celgard 2400 separator was placed on the top of the CNF electrode. 20 μL of testing electrolyte was added on the separator. Finally, a lithium metal anode was placed on the separator.

The cells were prepared with CNF paper cathodes and dissolved polysulfide catholytes to assess the surface stabilization effects of copper acetate on the metallic lithium anode. The macro-sized pores of the CNF paper permit direct contact of the corrosive polysulfides with the lithium metal anode. A relatively high cathode sulfur concentration of 50% by weight was chosen to assess the effects of the M-X additive under conditions promoting anode corrosion. LiNO₃ was added to the anode electrolyte to suppress polysulfide shuttling prior to formation of a stable passivation layer by the copper acetate additive.

The CNF paper current collectors were prepared by a dispersion-filtration process. 90 mg of CNF were dispersed in a miscible solution of de-ionized water (700 mL) and isopropyl alcohol (50 mL) and ultrasonicated for 15 minutes. The product was collected by vacuum filtration and washed with de-ionized water, ethanol, and acetone several times.

“Blank” electrolyte solution was prepared by dissolving LiCF₃SO₃ in a DME and DOL (1:1 v/v) mixture solvent. The final concentration of LiCF₃SO₃ was 1 M. Testing electrolyte was obtained by addition of LiNO₃ to a concentration of 0.3 M.

For experimental cells, copper acetate monohydrate was added to the testing electrolyte. The concentration of copper acetate monohydrate in the cells was 0.3 M. The copper acetate monohydrate was dried in an air-oven for 24 hours to remove any absorbed moisture before addition to the electrolyte.

The polysulfide catholyte contained 1-2 M sulfur with a nominal molecular formula of Li₂S₆. The catholyte was prepared by chemical reaction of commercially obtained sublimed sulfur and Li₂S in a 5:1 molar ratio for 18 hours at 45° C. in an Ar-filled glove box to produce a brownish red solution with moderate viscosity.

Galvanostatic cycling was conducted with an Arbin battery cycler at 2.6-1.8 V (vs. Li⁺/Li) at room temperature. The specific discharge capacity was calculated based on the mass of sulfur in the cells. Electrochemical impedance spectroscopy measurements were performed with a Solartron 1260A impedance analyzer in the frequency range of 1 MHz to 0.1 Hz with an AC voltage amplitude of 5 mV at the open-circuit voltage (OCV).

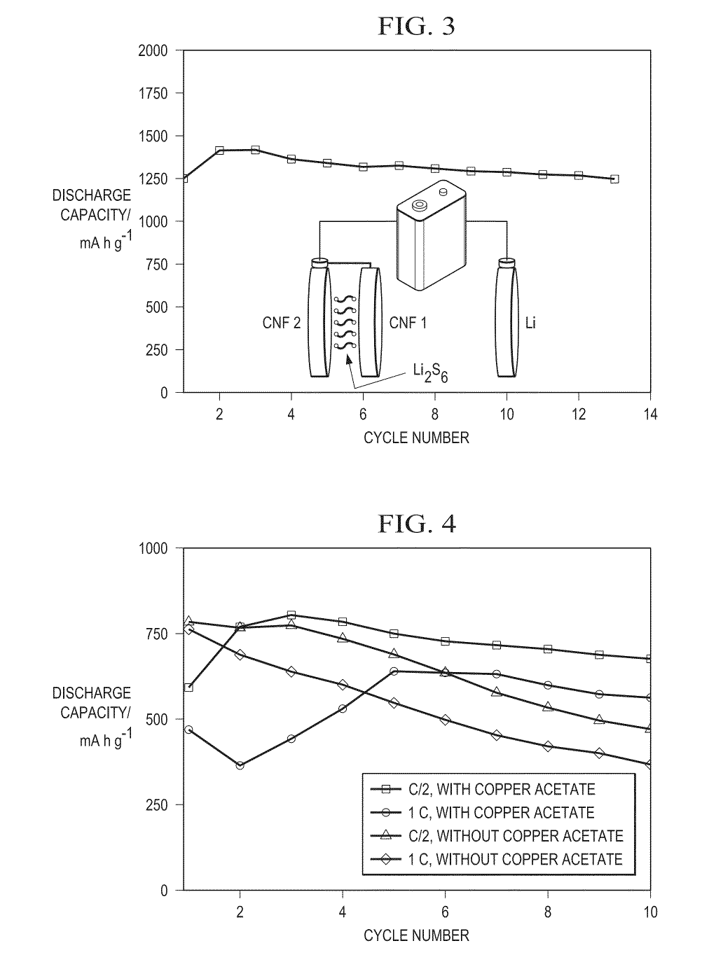

In addition to the foregoing single-layer cathode cells, sandwich-structured cathode cells as schematically illustrated in FIG. 3 were also assembled in CR2032 coin cells to assess the performance of Li—S batteries having a composite sulfur cathode and protected lithium-metal anode. First, 40 μL polysulfide catholyte was added into a CNF paper current collector. Then, a carbon- and polymer-coated CNF paper current collector was inserted, followed by insertion of a Celgard 2400 separator. 20 μL of the testing electrolyte was then added, and the lithium metal anode was inserted. The weight of the native and carbon-coated CNF paper current collectors was adjusted to ensure that the sulfur concentration (50 percent by weight) and loading (approximately 2 mg/cm²) was equal to the sulfur concentration and loading of the single-layer cells discussed above.

The carbon-coated CNF paper current collectors were prepared by slurry casting. 120 mg of CNF, 40 mg ketjenblack carbon nanopowder, 10 mg sodium alginate, and 10 mg polyvinyl alcohol were dispersed in a miscible solution of water (100 mL) and isopropyl alcohol (100 mL) and stirred under ultrasonication for 30 minutes to produce the film-forming slurry. The slurry was suspended on a nylon filter paper, washed with deionized water and ethanol, and dried for 24 hours. Alternatively, the slurry was suspended on a flat glass plate and naturally dried at room temperature. The resulting carbon-coated CNF papers were then punched out in circular discs of 1.2 cm in diameter. Additional materials for the sandwich-structured cathode cells were prepared as discussed above.

To assess the effect of the M-X additives in “conventional” cells of simple construction and having relatively inexpensive materials, “CR2032 coin cells having sulfur electrode disc cathodes and aluminum foil cathode collectors were assembled and tested. The cathode discs were composed of sulfur, a commercial carbon additive, and binder, with weight percentages of 50%, 40%, and 10% respectively. The sulfur loading was approximately 1.2 mg/cm². The electrolyte and anode were prepared as described above.

Lithium metal foil (99.9%) was purchased from Sigma-Aldrich (St. Louis, Mo.). Sublimed sulfur powder (99.5%), Li₂S (99.9%), LiCF₃SO₃ (98%), DME (99+%) DOL (99.5%) and LiNO₃ (99+%) were purchased from Acros Organics (New Jersey). Celgard® 2400 polypropylene separators used in batteries of these examples were purchased from Celgard (Charlotte, N.C.).

### i) Electrochemical Analysis

Cycling was performed at a rate of C/5 (1 C=1,672 mA/g). Discharge/charge voltage profiles for the first and second cycle in the control cell are shown in FIG. 1B. Discharge/charge voltage profiles for the first, 25^{th}, and 100^{th} cycles in the copper acetate-containing cells are shown in FIG. 1C.

In contrast to the lower voltage plateau of the discharge/charge voltage profile of the control cell without copper acetate shown in FIG. 1B, the lower-voltage plot of the copper acetate treated cells (FIG. 1C) appears as a sloping region. Without limitation to theory, it is believed that this sloping region is indicative of additional redox reactions among the copper acetate, polysulfides, and lithium metal. These conditioning reactions were complete after approximately 25 cycles, as indicated by the recovery of the upper plateau of the discharge/charge voltage profile of the copper acetate treated cells. After 100 cycles, classical discharge behavior of Li—S batteries was observed, wherein the upper plateau at approximately 2.25 V and adjacent sloping region correspond to the reduction of S/Li₂S₈ to Li₂S₄, and wherein the lower voltage plateau at approximately 2.0 V corresponds to the reduction of Li₂S₄ to Li₂S₂/Li₂S. Corresponding oxidation plateaus at approximately 2.35 V and 2.5 V were observed in the charging cycle.

FIG. 1D illustrates the cycling performance of control cells and additive cells containing copper acetate (“experimental cells”). As shown, the discharge capacity of the additive cell is lower than that of the control cell over the first several cycles. Without limitation to theory, this is possibly due to formation of a passivation layer on the surface of the lithium metal in the experimental cells. The control cell exhibited a sudden reduction in capacity and Coulombic efficiency approaching the 100^{th} cycle. Such reduction may be due to dendrite formation on the lithium anode or due to depletion of the electrolyte due to parasitic reactions. In contrast, the experimental cell exhibited stable discharge capacity and Coulombic efficiency, with a capacity retention of 75% after 300 cycles and a Coulombic efficiency of 100% for most cycles.

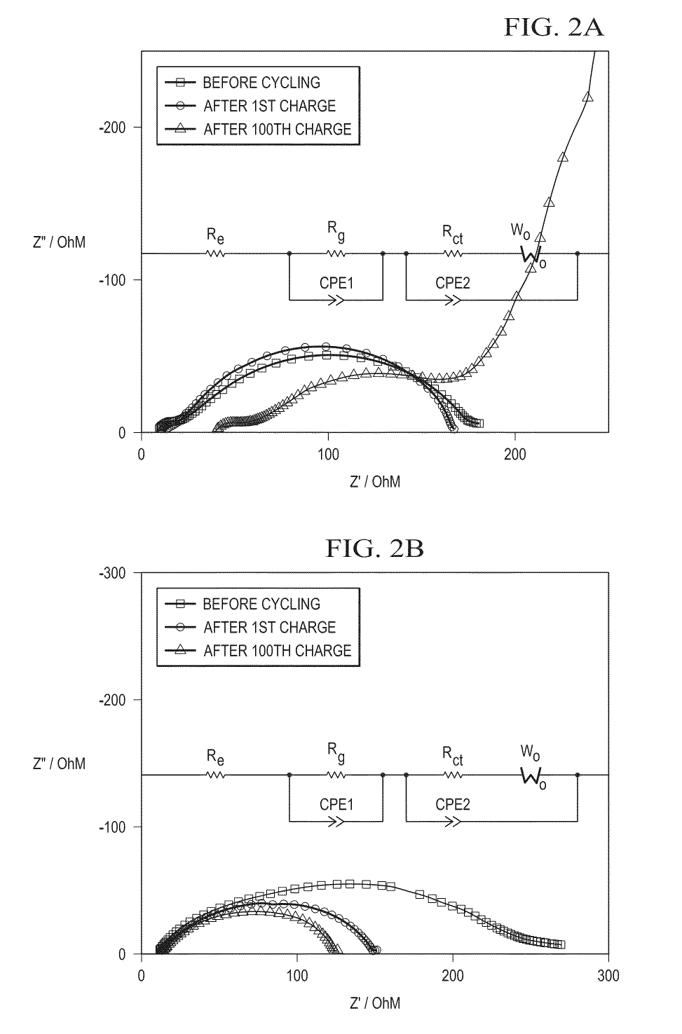

Similar results were observed by Electrochemical Impedance Spectroscopy (“EIS”). FIG. 2A shows Nyquist plots for the control cell before cycling, after the first charge, and after the 100^{th} charge, while FIG. 2B shows Nyquist plots for the additive cell before cycling, after the first charge, and after the 100^{th} charge. The plots shown in FIG. 2A and FIG. 2B depict the impedance of the cells (“Z”) observed at a given frequency, with frequency (“f”) decreasing along the x-axis. The corresponding circuit is also illustrated: Rₑ represents electrolyte resistance; R_{g} represents resistance from the passivation layer on the surface of the lithium anode; R_{ct} represents charge transfer resistance; Wₒ represents Warburg impedence; and CPE1 and CPE2 are phase constants.

As shown by the EIS results, the control cell demonstrates an increase in electrolyte resistance and evolution of a linear plot segment in the low-frequency region after 100 cycles (FIG. 2A) while the additive cell maintains a conserved impedance spectrum with lower resistance relative to the control cell (FIG. 2B).

FIG. 3 illustrates cycling performance of the sandwich-structured cathode cell with copper acetate at a discharge rate of C/5. While the sulfur loading of the sandwich-structured cathode cells is the same as single-layer current collector cells discussed above, the reversible discharge capacity is increased to approximately 1,300 mA*h/g.

FIG. 4 illustrates performance of cells with and without copper acetate at discharge rates of C/2 and 1C. Both control cells and additive cells were constructed with sandwich-structured cathodes as discussed. Sulfur concentration and loading were maintained for control and additive cells.

The initial discharge capacity of the additive cell containing copper acetate is lower than the discharge capacity of the control cell at the higher discharge rates tested (C/2 and 1 C), consistent with the EIS results demonstrating the additive cell has higher resistance before cycling, possibly because the passivation film is relatively thick in this polysulfide electrolyte environment. However, the capacity retention of the additive cell is improved relative to the control cell, and the additive cell exhibits higher discharge capacity than the control cell after a few cycles. The control cell exhibits a significant decrease in capacity after just a few cycles at high discharge rate.

Without limitation to theory, the improved high rate performance of additive cells relative to control cells may be due to the lower resistance of the additive cell with cycling as shown by the EIS results discussed above. The additive cell is believed to exhibit lower resistance relative to the control cell because there is no significant passivation of large insulating Li₂S particles or polysulfides on the anode surface of the experimental cell, resulting in greater ionic conductivity of the passivation layer that is formed in the experimental cell. It is further believed that lithium is uniformly deposited on the anode of the experimental cell, resulting in sustained electronic conductivity.

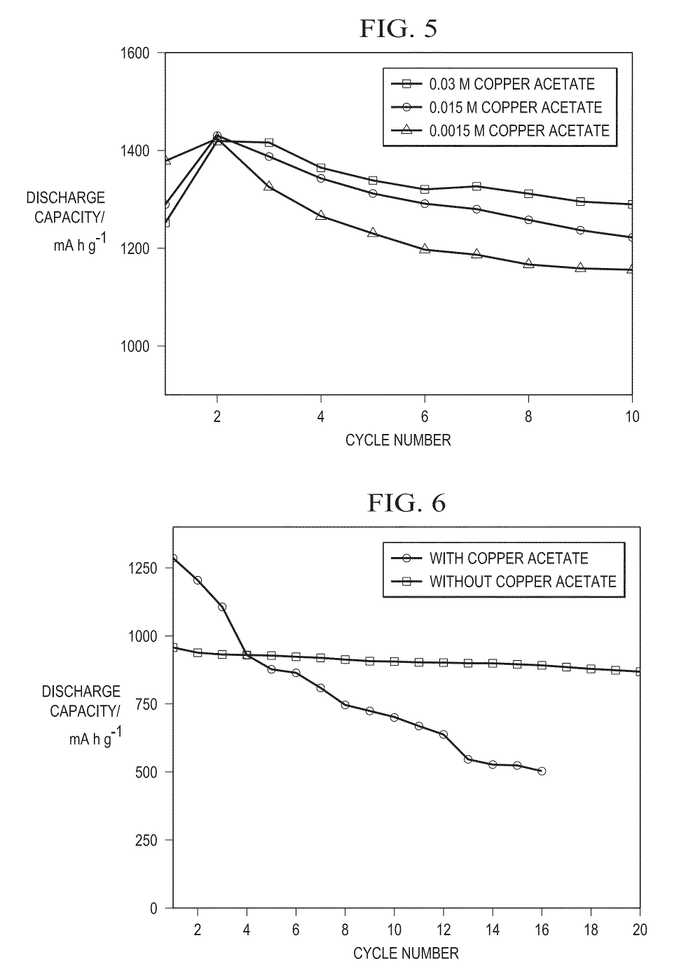

The influence of copper acetate concentration on electrochemical performance of Li—S batteries was evaluated in cells with sandwich-structured cathodes. Electrolyte copper acetate concentrations of 0.03, 0.015, and 0.0015 M were evaluated. As shown in FIG. 5, the 0.03 M copper acetate cell exhibited lower initial discharge capacity and higher capacity retention than the cells containing 0.015 M and 0.0015 M copper acetate. After several cycles, the cells containing 0.03 M copper acetate exhibit greater discharge capacity than the cells having lower electrolyte concentrations of copper acetate.

The electrochemical performance of “conventional” cells containing sulfur disc electrodes with aluminum foil as the current collector and electrolyte with or without M-X additive (copper acetate) was also evaluated by galvanostatic cycling. As shown in FIG. 6, the cells with electrolyte containing copper acetate exhibited lower initial discharge capacity and higher capacity retention than control cells. After several cycles the additive-containing cells exhibit greater discharge capacity than control cells.

### Anode Chemical and Morphological Analysis

The chemical and structural effects of the copper acetate additive on the lithium metal anode were evaluated for cells prepared with single-layer CNF paper cathodes and cycled as described.

Morphology of the surface of the lithium anode of was examined by scanning electron microscopy/energy-dispersive X-ray spectroscopy (SEM/EDS, FEI Quanta 650) after the first and 100^{th} charges of the cells.

Chemical species of interest (lithium, sulfur, and copper) were mapped by time-of-flight secondary ion mass spectrometry (TOF-SIMS) at the surface of the passivation layer on the surface of the lithium metal anode. Using a TOF/SIMS5 machine from ION-TOF GmbH, areas of 100 um² were raster scanned at 256×256 pixels in Burst Alignment mode with high spatial resolution (<200 nm) and high mass resolution (>5000, m/δm) by a 30 kV Bi₁⁺ primary ion beam with a 0.04 pA measured sample current. To enhance secondary ion signals of species of interest and to reduce possible interference of the chemical composition of the passivation layer by electrolyte residuals, the analyzed area was located centrally within an area of 250 um2 previously sputtered for 60 seconds by a secondary ion beam (Cs⁺ with 2 kV energy and approximately 85 nA measured sample current). All detected secondary ions had negative polarity. The mapping was performed in UHV at a base pressure of <10⁻⁹ mbar.

Characterization of the crystal structure of the lithium metal anode surface was performed by X-ray diffraction using a Rigaku X-Ray diffractor. The characterization was conducted with CuKα radiation at 10°-80° at a scan rate of 0.02° per second. Kapton film was used to protect the cycled lithium metal during characterization.

The surface chemistry composition of the lithium metal anode was examined by X-ray photoelectron spectroscopy (XPS) analysis with a Kratos Analytical spectrometer and monochromatic Al Kα (1486.6 eV) X-ray source at room temperature. Spectra were fitted in CasaXPS software with Voigt functions after subtraction of a Shirley-type background. Constraints on the sulfur component peaks were applied based on (i) the energy difference of 1.18 eV between S 2p3/2 and S 2p1/2 peaks; (ii) the peak area ratio of 2:1 between S 2p3/2 and S 2p1/2 peaks; and (iii) equal full-widths at half-maximum.

UV-visible absorption spectroscopy analysis was performed to identify polysulfide species after the 100^{th} charge. The cycled CNF paper electrode was soaked in 10 mL DOL/DME (1:1 ratio, by volume) for 5 minutes. The cathode analyte was characterized using a Cary 5000 Spectrophotometer with Varian baseline correction.

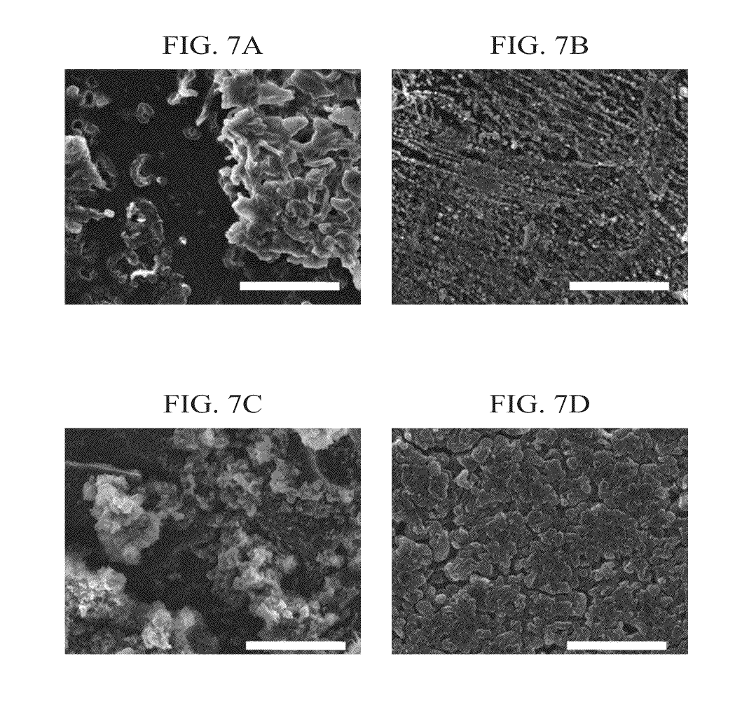

Scanning electron microscopy (SEM) micrographs of the lithium metal anode surface are provided in FIGS. 7A-7D. FIGS. 7A and 7C depict the surface of the lithium anode from a control cell after the first and 100^{th} charge, respectively; FIGS. 7B and 7D depict the surface of the lithium anode from an experimental cell after the first and 100^{th} charge, respectively. The cells were cycled at a rate of C/5.

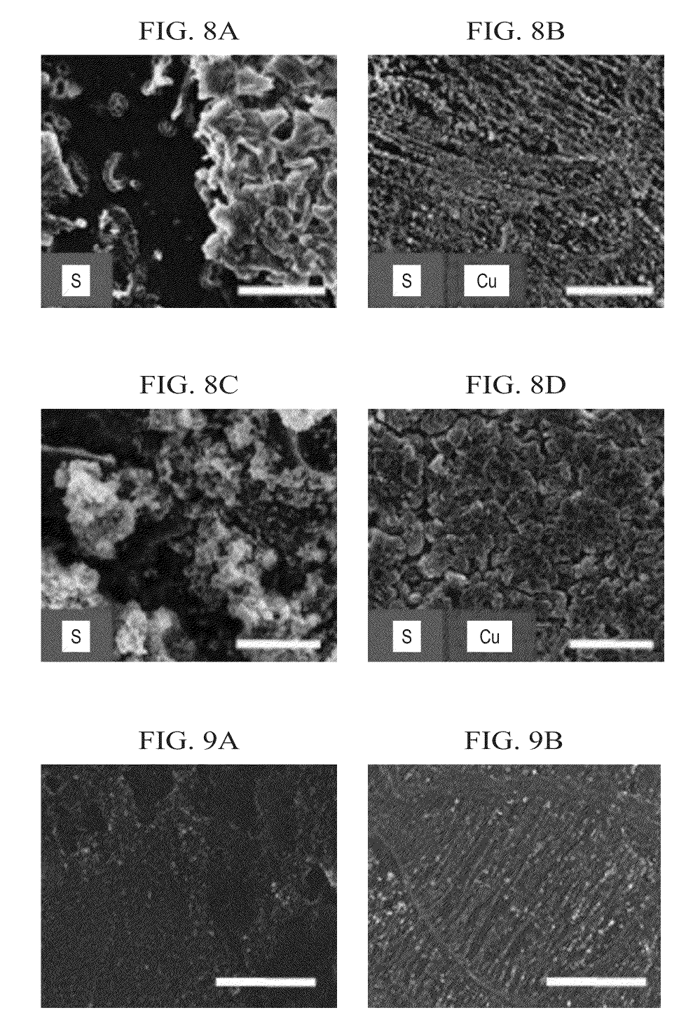

Corresponding energy-dispersive X-ray spectroscopy (EDS) results are provided in FIGS. 8A-8D. FIGS. 8A and 8C depict the surface of the lithium anode from a control cell after the first and 100^{th} charge, respectively; FIGS. 8B and 8D depict the surface of the lithium anode from an experimental cell after the first and 100^{th} charge, respectively. Sulfur deposits are displayed in red, and copper deposits are displayed in blue. The scale bars for FIGS. 7A-7D and 8A-8D represent a length of 100 um.

As shown in FIGS. 7A and 8A, after the first charge, the anode surface of the control cell is characterized by bulk precipitates of Li₂S/Li₂S₂ and non-uniform mossy lithium deposits, indicating that the LiNO₃ electrolyte additive did not preserve lithium morphology in the polysulfide-rich cell. In contrast, and as shown in FIGS. 7B and 8B, after the first charge, the surface of the anode in the experimental cell is relatively smooth and is covered by a sulfur- and copper-containing passivation layer. After the 100^{th} charge, as shown in FIGS. 7C and 8C, the control cell anode surface exhibited dendritic morphology and build-up of sulfur containing products, whereas the experimental cell anode surface exhibited uniform lithium deposition, as shown in FIGS. 7D and 8D. Without limitation to theory, it is believed that the uniform lithium deposition after multiple cycles in experimental cells is a result of the reduced anode surface roughness observed after the first cycle, as sulfur- and copper-containing deposits filled in surface pits caused by lithium extraction and protected the lithium surface from bulk Li₂S/Li₂S₂ deposition. Lithium extraction from the surface of the anodes after the first discharge of the control cell and experimental cell is shown in FIG. 9A and FIG. 9B, respectively.

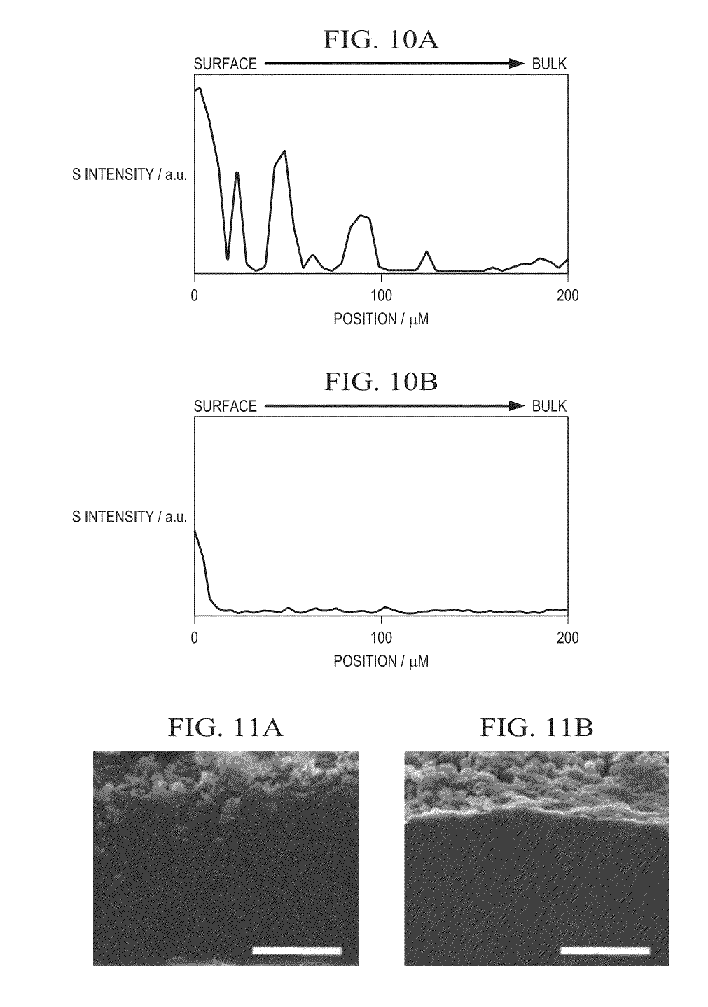

FIGS. 10A and 10B are EDS line scans for sulfur of a cross-section of the lithium metal anode of the control cell and experimental cell, respectively, after the 100^{th} charge. The scales in FIG. 10A and FIG. 10B represent the position in the cross-section of the lithium metal anodes. As shown, sulfur is deposited to a significant depth in the control cell anode, whereas in the experimental cell anode, sulfur is concentrated in a layer coating the surface of the lithium. These results indicate that the passivation layer in the experimental cell effectively prevents penetration of migrating polysulfides and associated contamination of the lithium electrode. Without limitation to theory, it is believed that prevention of polysulfide penetration can inhibit the formation of dendritic structures from the interior of the electrode.

FIGS. 11A and 11B are corresponding SEM images of the cross-section of the lithium metal anode of the control cell and experimental cell, respectively, after the 100^{th} charge.

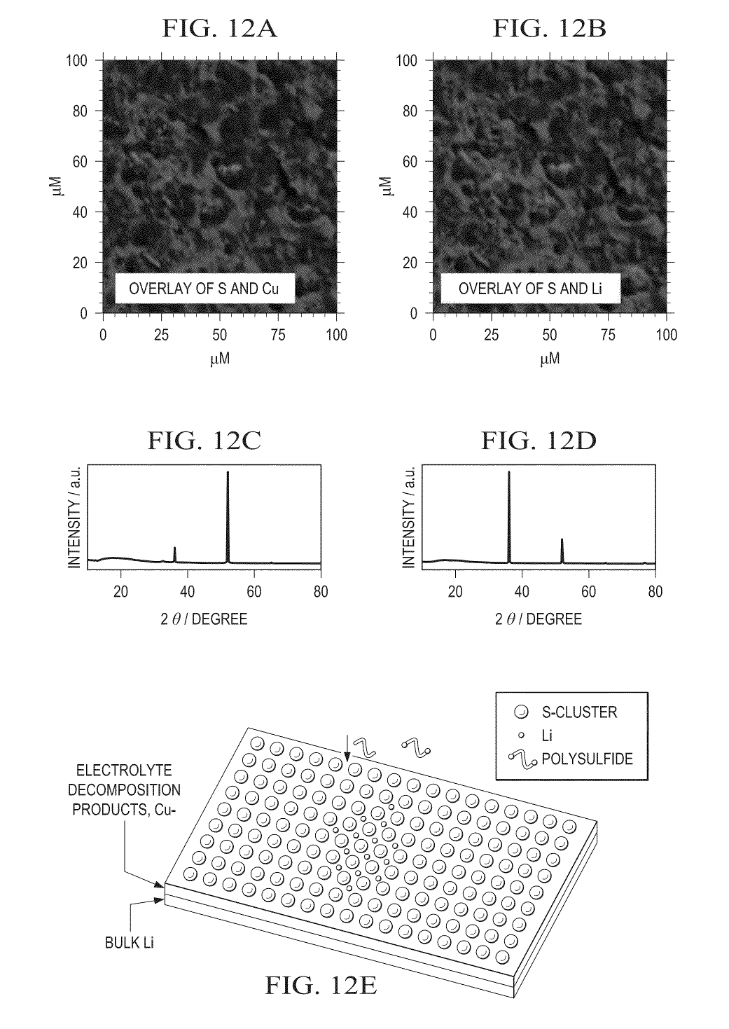

TOF-SIMS analysis was conducted to determine lithium deposition through the sulfur- and copper-containing passivation layer in the experimental cell after the first charge. FIG. 12A depicts the observed TOF-SIMS chemical mapping image overlay of sulfur (shown in red) and copper (shown in blue); FIG. 12B depicts the observed TOF-SIMS chemical mapping image of sulfur (shown in red) and lithium (shown in blue). Lithium exhibits extensive overlapping with copper and is densely deposited in the interstices of sulfur-containing clusters. Without limitation to theory, the presence of the copper on the surface of the lithium may suppress the formation of bulk Li₂S particles due to interaction between copper and sulfur species, thereby interrupting the formation of crystalline Li₂S.

XRD analysis of the lithium anode surface of the experimental cell after the first discharge and first charge is shown in FIG. 12C and FIG. 12D, respectively. Two peaks are observed in both FIG. 12C and FIG. 12D at 2θ=36.0° and at 2θ=51.2°. These peaks correlate to the (011) and (002) peaks of crystalline lithium. The relative intensity of the peaks changes between charge and discharge, indicating lithium deposition with a preferential orientation, rather than bulk lithium metal deposition. This preferential orientation is believed to be due to the presence of the passivation layer, and could result in particulate rather than dendritic deposition of lithium as observed with control cells (cf. FIG. 7A and FIG. 7C). Absence of crystalline Li₂S on the surface of the lithium anode in the experimental cell was confirmed by XRD analysis, which shows no Li₂S signals.

It is evident from the TOF-SIMS and XRD analyses that lithium deposition is influenced by the passivation layer associated with copper acetate. Without limitation to theory, it is believed that lithium ions deposit in the interstices of evenly distributed sulfur-containing clusters, in close proximity to copper species and the lithium anode. Surface roughness is thereby reduced relative to control cell anodes and dendrite formation is avoided. A schematic model of lithium deposition associated with addition of copper acetate to the electrolyte is provided in FIG. 12E, with sulfur clusters shown as large blue dots and lithium ions shown as small red dots. As depicted, larger polysulfide decomposition products are excluded.

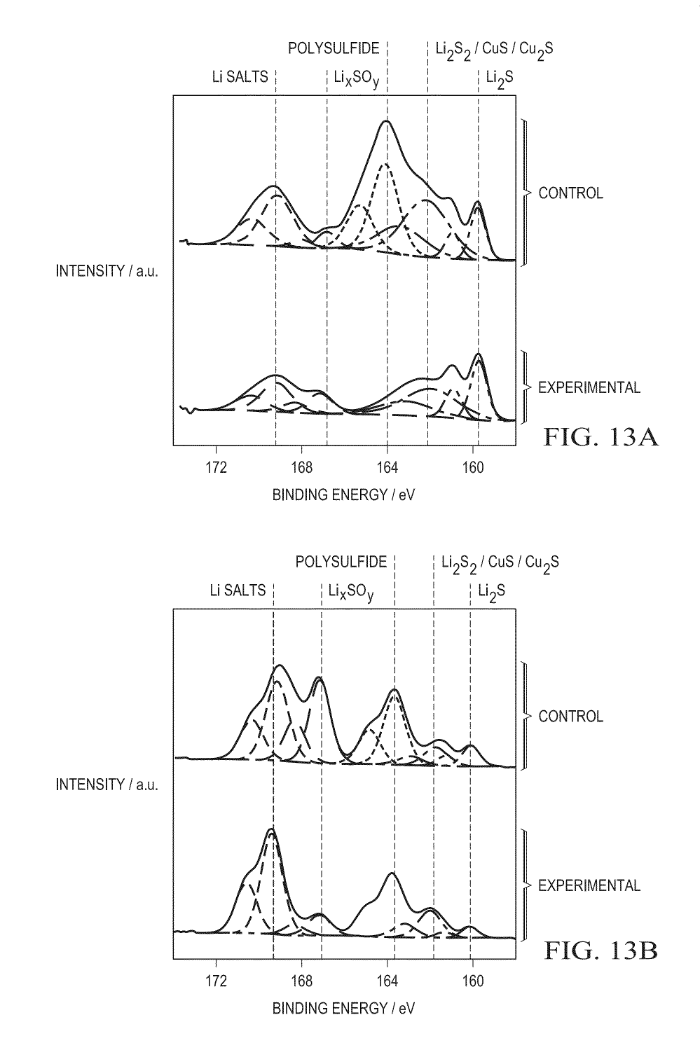

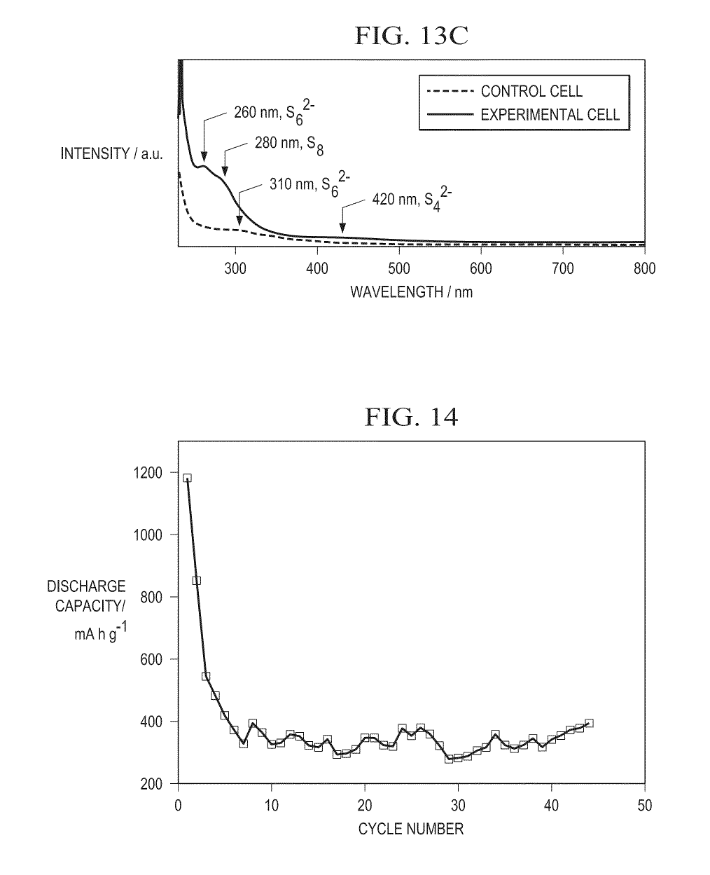

XPS analysis was conducted to examine the effect of copper acetate on the surface chemistry of the lithium anode. FIG. 13A depicts the S 2p XPS spectra of the lithium surface of control and experimental cells after the first charge; FIG. 13B depicts the S 2p XPS spectra of the lithium surface of control and experimental cells after the 100^{th} charge. Corresponding chemical compositions observed after the first charge and after the 100^{th} charge are provided in Table 1 and Table 2, respectively, below.

TABLE 1
XPS Spectra Analysis of Lithium
Anode Surfaces After One Charge

| | Li | | Poly- | | |
|---|---|---|---|---|---|
| | salts | LiₓSO_{y} | sulfide | Li₂S₂/CuS/Cu₂S | Li₂S |
| B.E. (eV) | 169.1 | 166.8~167.1 | 164.1 | 162.0~162.2 | 159.8 |
| Control | 21.1% | 4.1% | 30.7% | 33.9% | 10.2% |
| cell | | (166.8 eV) | | (162.2 eV) | |
| Experi- | 23.1% | 13% | 0 | 38.6% | 25.3% |
| mental | | (167.1 eV) | | (162.0 eV) | |
| cell | | | | | |

TABLE 1
XPS Spectra Analysis of Lithium
Anode Surfaces After 100 Charges

| | Li | | Poly- | | |
|---|---|---|---|---|---|
| | salts | LiₓSO_{y} | sulfide | Li₂S₂/CuS/Cu₂S | Li₂S |
| B.E. (eV) | 169.1~169.3 | 167.2 | 163.7 | 161.7~161.9 | 160.1 |
| Control | 31.0% | 29.5% | 25.7% | 7.6% | 6.2% |
| cell | (169.1 eV) | | | (161.7 eV) | |
| Experi- | 47.0% | 10.4% | 25.3% | 13.3% | 4.0% |
| mental | (169.3 eV) | | | (161.9 eV) | |
| cell | | | | | |

As shown in FIG. 13A, it was observed that the lithium surface of the experimental cell exhibited much less polysulfide adhesion after the first charge relative to the polysulfide adhesion observed for the control cell, as indicated by the disappearance of the S 2p3/2 peak at 164.1 eV. The passivation layer on the lithium surface in the experimental cell is composed primarily of Li₂S, Li₂S₂/CuS/Cu₂S species, lithium salts, and electrolyte decomposition products, which are identified, respectively, at 159.8, 162.1, 169.1, and 167.0 eV.

As shown in FIG. 13B, after 100 cycles, the concentration of electrolyte decomposition products (e.g., sulfite or sulfone species) increased for the control cell anode but not the experimental cell anode, indicating that fewer parasitic reactions occurred on the lithium surface in the experimental cell and indicating greater stability of the passivation layer in the experimental cells relative to the stability of the lithium surface in control cells.

UV-visible absorption spectroscopy analysis was performed on the cathode analyte after the 100^{th} charge to verify chemical composition of species observed in the cycled electrodes. The spectra for the control cell and experimental cell are shown in FIG. 13C. As depicted, the experimental cell analyte exhibited strong absorption peaks at ˜310 nm attributed to S₆ species relative to the control cell analyte. The experimental cell analyte further exhibited peaks at ˜260 nm, ˜280 nm, and ˜420 nm, corresponding with S₆²⁻, S₈, and S₄²⁻ species, respectively, with intensities greater than the analyte of the control cell. The relative abundance of these species in the analyte of experimental cells relative to control cells further indicates that fewer parasitic reactions occurred between polysulfides and lithium material in the experimental cell, with associated conservation of the active electrode and catholyte materials.

### Example 2

Electrochemical cells having high sulfur content were constructed to determine the effect of MX electrolyte additives on electrochemical performance under highly lithium metal anode-corrosive conditions.

CR2032 coin cells were constructed with conventional sulfur cathode discs composed of sulfur, a commercial carbon additive, and polyvinyl difluoride binder, with weight percentages of 60%, 30%, and 10% respectively. Aluminum foil was used as the current collector. The sulfur loading was approximately 1.5 mg/cm². The electrolyte was prepared by dissolving LiCF₃SO₃ (1 M) and various concentrations of LiNO₃ in DME and DOL (1:1 v/v) mixture solvent. In experimental cells, an MX electrolyte additive was added to the electrolyte. The electrochemical performance of the cells was assessed at various discharge rates by galvanostatic cycling conducted with an Arbin battery cycler at 2.6-1.8 V (vs. Li⁺/Li) at room temperature. The specific discharge capacity was calculated based on the mass of sulfur in the cells.

Cycle Stability of Li—S Batteries without MX Electrolyte Additive

Cycling performance of the control cells at a discharge rate of C/2 and 0.1 M LiNO₃ is plotted in FIG. 14. As shown, the control cell Li—S batteries exhibit capacity fade after only a few cycles.

### Effect of Copper Nitrate Electrolyte Additive on Cycle Stability and Resistance of Li—S Batteries

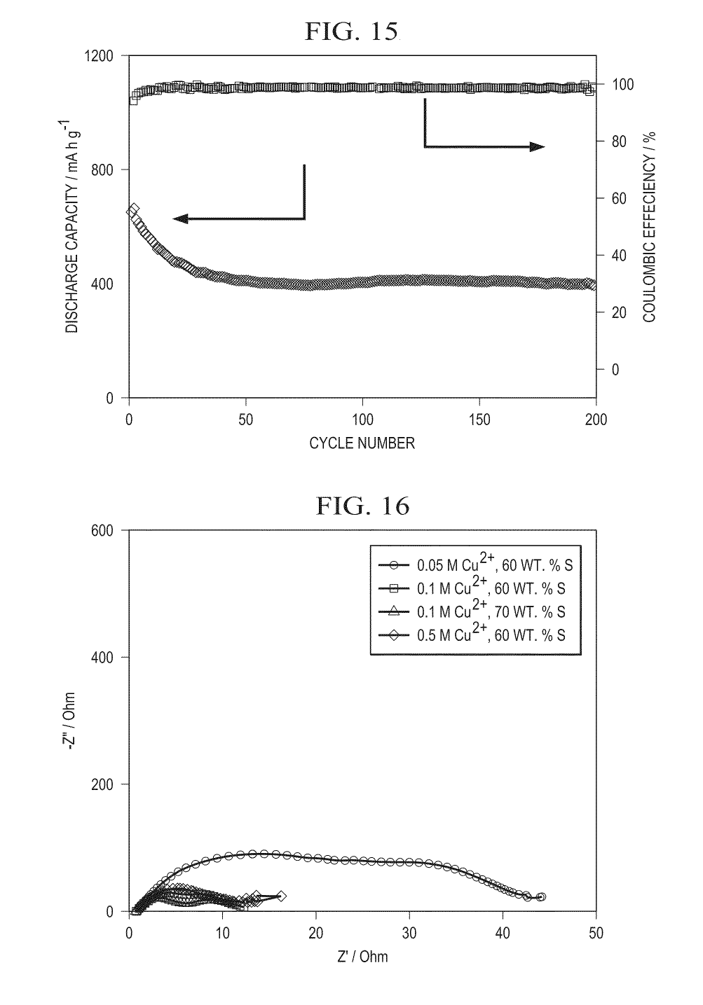

Cycling performance and Coulombic efficiency data of experimental cells containing 0.05 M LiNO₃ and copper nitrate (Cu(NO₃)₂) electrolyte additive at a high discharge rate of 1 C is plotted in FIG. 15. As depicted, stable cycling is achieved by the addition of copper nitrate as an electrolyte additive.

EIS measurements were performed on experimental cells containing copper nitrate at various concentrations with a Solartron 1260A impedance analyzer in the frequency range of 1 MHz to 0.1 Hz with an AC voltage amplitude of 5 mV at the open-circuit voltage (OCV). Cells contained copper nitrate at a concentration of 0.05 M, 0.1 M, or 0.5 M. An additional cell containing both 0.1 M copper nitrate and a cathode constructed as described but containing 70% sulfur by weight was also prepared.

Nyquist plots of observed EIS measurements are plotted in FIG. 16. As shown, cell resistance decreases with addition of copper nitrate. Increasing the concentration of copper nitrate from 0.05 M to 0.1 M significantly decreases cell resistance, but a similar increase is not observed upon increasing the concentration from 0.1 M to 0.5 M. Without limitation to theory, it is believed that the decrease in cell resistance is due to formation of a stable passivation layer on the lithium metal anode, and plateaus due to complete passivation with 0.1 M copper nitrate. Cell resistance was not changed by increasing the sulfur concentration of the cathode from 60% to 70% by weight.

### Effect of Copper Fluoride Electrolyte Additive on Cycle Stability of Li—S Batteries

Cycling performance of experimental cells containing 0.1 M LiNO₃ and copper fluoride (CuF₂) electrolyte additive at a discharge rate of C/2 is plotted in FIG. 17. As depicted, relatively stable cycling is achieved by the addition of copper fluoride as an electrolyte additive

### Effect of Copper Acetate, Nickel (II) Acetate, and Iron (II) Acetate Electrolyte Additives on Cycle Stability of Li—S Batteries

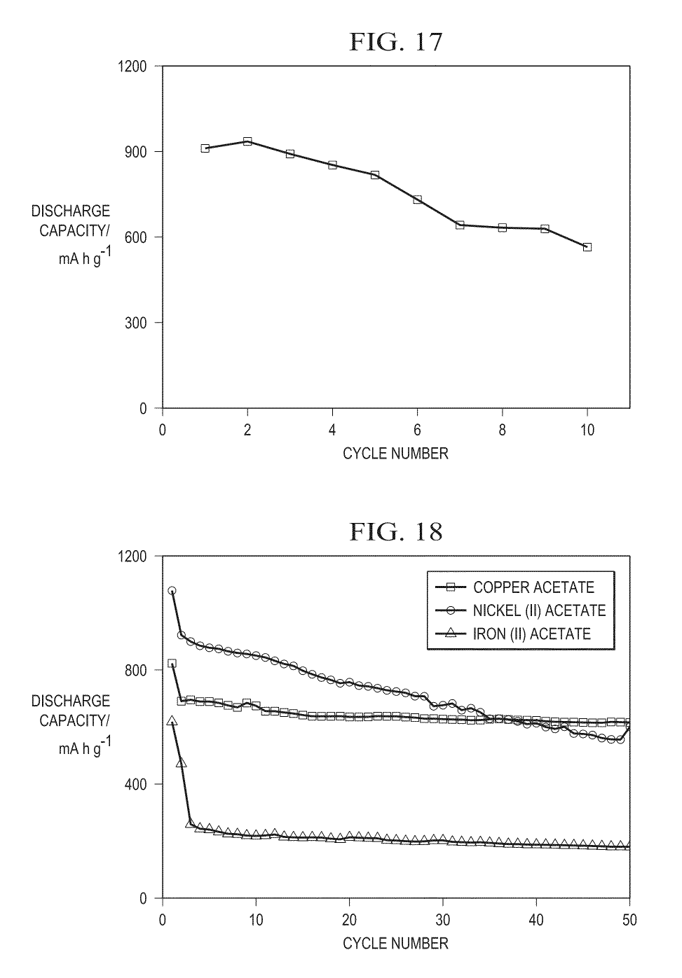

Cycling performance of experimental cells containing 1 M LiNO₃ and copper acetate, nickel (II) acetate (Ni(CH₃COO)₂), or iron (II) acetate (Fe(CH₃COO)₂) electrolyte additive at a discharge rate of C/2 is plotted in FIG. 18. The electrolyte additives were associated with varying initial capacities and cycle stability as shown. Ni²⁺ results in the highest sulfur utilization in the first cycle, but exhibits lower capacity retention relative to Cu²⁺ and Fe²⁺. The initial capacity in experimental cells containing Fe²⁺ was observed to be low relative to the initial capacities observed for Ni²⁺ and Cu²⁺.

Although only exemplary embodiments of the disclosure are specifically described above, it will be appreciated that modifications and variations of these examples are possible without departing from the spirit and intended scope of the disclosure. For instance, numeric values expressed herein will be understood to include minor variations and thus embodiments “about” or “approximately” the expressed numeric value unless context, such as reporting as experimental data, makes clear that the number is intended to be a precise amount. Additionally, one of ordinary skill in the art will appreciate that a cathode containing MWCNT and catholyte or microparticles as described herein or a cathode/catholyte combination may be prepared in accordance with the present disclosure independently from the anode. Such cathodes or cathode/catholyte combinations would clearly be intended for use in batteries of the present disclosure.

1. A lithium-sulfur battery comprising:
an anode comprising metallic lithium;
at least one of a cathode comprising electroactive sulfur or a catholyte comprising electroactive sulfur; and
an electrolyte comprising an additive having the formula M-X, wherein M is a transition metal and X is an anion.

2. The battery of claim 1, wherein the battery further comprises a passivation layer on the anode formed from the additive.

3. The battery of claim 1, wherein the passivation layer has a three dimensional matrix structure.

4. The battery of claim 3, wherein the passivation layer comprises Li₂S, Li₂S₂, and material having the general formula MS, wherein M is the transition metal from the electrolyte.

5. The battery of claim 3, wherein the passivation layer further comprises an electrolyte decomposition product.

6. The battery of claim 1, wherein the M is Cu.

7. The battery of claim 3, wherein the passivation layer comprises Li₂S, Li₂S₂, CuS and Cu₂S.

8. The battery of claim 7, wherein the passivation layer further comprises an electrolyte decomposition product.

9. The battery of claim 1, wherein the cathode comprises elemental sulfur.

10. The battery of claim 9, wherein the elemental sulfur is selected from the group consisting of: crystalline sulfur, amorphous sulfur, precipitated sulfur, and melt-solidified sulfur, sulfides, polysulfides, sulfur oxides, organic materials comprising sulfur, and any combinations thereof.

11. The battery of claim 9, wherein the cathode comprises a conductive coating on the elemental sulfur.

12. The battery of claim 11, wherein the conductive coating comprises conductive carbon and one or more polymers.

13. The battery of claim 1, wherein the cathode and electrolyte comprise a polysulfide catholyte.

14. The battery of claim 13, wherein the catholyte comprises a compound with the formula Li₂Sₙ, where 4≦n≦8.

15. The battery of claim 13, wherein the cathode further comprises a conductive electrode.

16. The battery of claim 15, wherein the conductive electrode comprises a carbon electrode.

17. The battery of claim 1, wherein the electrolyte comprises a nonaqueous electrolyte.

18. The battery of claim 17, wherein the electrolyte comprises a nonionic liquid, an organic liquid, or a combination thereof.

19. The battery of claim 17, wherein the electrolyte comprises a solvent selected from the group consisting of an acyclic ether, a sulfone, or any combination thereof.

20. The battery of claim 17, wherein the electrolyte comprises a lithium electrolyte salt.

21. The battery of claim 20, wherein the lithium electrolyte salt is selected from the group consisting of LiSCN, LiBr, LiI, LiClO4, LiAsF₆, LiCF₃SO₃, LiSO₃CH₃, LiBF₄, LiB(Ph)₄, LiPF₆, LiC(SO₂CF₃)₃, and LiN(SO₂CF₃)₂, and any combinations thereof.
